(19) United States
(12) Patent Application Publication
(10) Pub. No.: US 2007/0240560 A1
(43) Pub. Date: Oct. 18, 2007

(54) Musical Instrument

(76) Inventor: James Lee Plamondon, Busselton (AU)

Correspondence Address: BUCHANAN, INGERSOLL & ROONEY PC, POST OFFICE BOX 1404, ALEXANDRIA, VA, 22313-1404, US

(21) Appl. No.: 10/585,579

(22) PCT Filed: Jan. 7, 2005
(86) PCT No.: PCT/AU05/00009

§ 371 Date: Sep. 14, 2006

(30) Foreign Application Priority Data
Jan. 9, 2004 (AU) 2004900085

(51) Int. Cl. G10H 1/32

(52) U.S. Cl. 84/744

(57) ABSTRACT

An electronic musical instrument including: at least one finger activated note identifier input button located in a primary playing zone; and at least one thumb activated input device located in a secondary playing zone; wherein the arrangement of said primary and secondary zones permits simultaneous operation of said at least one finger activated input button and said at least one thumb activated input device.

### FIELD OF THE INVENTION

The present invention relates to musical instruments and, in particular, to a polyphonic electronic musical instrument and controller.

### BACKGROUND OF THE INVENTION

There exists a large range of known conventional or acoustic musical instruments such as pianos, brass, reed and string instruments. The piano has polyphony (i.e., can play many notes at once) but few expressive controls, these being velocity sensitivity, reduced string damping (sustain or loud pedal) and increased string damping (soft pedal). Other types of acoustic instruments can offer more expressive control through the interaction of lip muscles and mouthpieces and reeds, fingers or bows on strings, but the polyphony of these instruments is low.

Different forms of electronic synthesisers and MIDI input controllers have also tried to emulate a wide variety of acoustic instruments and add a limited number of additional expression devices. On keyboard synthesizers, for example knobs, sliders, and wheels are often provided to allow the player to enhance the expression of the selected notes. However, the player must usually stop selecting notes with one hand to manipulate the expression controls with that hand. This trades away polyphony for expression. Another disadvantage of the piano style keyboard used on pianos and most polyphonic electronic instruments is the size and weight of the input or control surface (the keyboard).

One of the major advantages of the piano keyboard is that its keys are all visible to the pianist when playing, which helps novices locate and select its keys. As a counter-example, a concertina's button-fields are not visible to the concertinist when playing, since the concertina's button-fields are (a) usually facing away from the concertinist's eyes, and (b) usually in motion at either end of the concertina's bellows. This is a significant impediment to learning to play the concertina compared to the piano.

It is therefore an object of the present invention to provide a new musical instrument which provides relatively greater expressiveness and polyphony than existing instruments, and ideally also providing ease-of-learning benefits.

### SUMMARY OF THE INVENTION

With the above object in mind the present invention provides in one aspect a portable user operated button-field electronic music controller including:

at least one finger actuated note identifier input button in a first zone actuated by at least one finger of a users first hand to generate at least one note identifier output used to create one or more musical notes, said at least one finger actuated note identifier input button arranged to be actuable by each of at least one finger of said users first hand; and

at least one thumb actuated effect identifier input device in a second zone actuated by said users thumb on said first hand to generate at least one effect identifier output used to modify said one or more musical notes;

wherein the arrangement of said first and second zones allows simultaneous operation of said at least one finger actuated note identifier input button and said at least one thumb actuated effect identifier input device.

In another aspect of the present invention a portable user operated electronic music controller including:

at least one finger actuated note identifier input device in a first zone actuated by at least one finger of a users first hand to generate at least one note identifier output used to create one or more musical notes, said at least one finger actuated note identifier input device arranged to be actuated by each of at least one finger of said users first hand; and

at least one thumb actuated effect identifier input device in a second zone actuated by said users thumb on said first hand to generate at least one effect identifier output used to modify said one or more musical notes;

wherein the arrangement of said first and second zones allows simultaneous operation of said at least one finger actuated note identifier input device and said at least one thumb actuated effect identifier input device.

In the preferred embodiment, the primary purpose of the at least one finger actuated note identifier input device is to generate music note values, so said signals generated by said finger actuated note identifier input device may include music note values. However, additional expression can be added by the use of force, pressure or velocity sensitivity for example, so a secondary purpose of the at least one finger actuated note identifier input device may be to generate music effect values. Other secondary uses are envisaged such as the selection of music effects and the entry or manipulation of instrument metadata.

Similarly, the primary purpose of the at least one thumb actuated effect identifier input device in the preferred embodiment is to enhance the musical expression of the notes selected by the fingers, so said signals generated by said thumb actuated effect identifier input device may include music effects, music effect values, and chord variations. However, the thumb actuated effect identifier input device can also have secondary uses such as the generation of music note values and the generation or manipulation of instrument metadata.

In a further aspect the present invention provides a portable user operated electronic music controller including:

at least one finger actuated note identifier input device in a first zone actuated by at least one finger of a users left hand to generate at least one note identifier output used to create one or more musical notes, said at least one finger actuated note identifier input device in said first zone arranged to be actuated by each of at least one finger of said users left hand; and

at least one thumb actuated effect identifier input device in a second zone actuated by said users thumb on said left hand to generate at least one effect identifier output used to modify said one or more musical notes;

wherein the arrangement of said first and second zones allows simultaneous operation of said at least one finger actuated note identifier input device in said first zone and said at least one thumb actuated effect identifier input device in said second zone by said left hand of said user;

said controller further including:

at least one finger actuated note identifier input device in a third zone actuated by at least one finger of a users right hand to generate at least one note identifier output used to create one or more musical notes, said at least one finger actuated note identifier input device in said third zone arranged to be actuated by each of at least one finger of said user's right hand; and

at least one thumb actuated effect identifier input device in a fourth zone actuated by said users thumb on said right hand to generate at least one effect identifier output used to modify said one or more musical notes;

wherein the arrangement of said third and fourth zones allows simultaneous operation of said at least one finger actuated note identifier input device in said third zone and said at least one thumb actuated effect identifier input device in said fourth zone by said right hand of said user.

The preferred embodiment includes two portions, the first portion with the first and second playing zones as described above, and the second portion with the third and fourth playing zones as described above.

Ideally these two portions are joined together by means of a hinge.

The signals generated by the digit-activated controllers may be transmitted from said electronic musical instrument to other devices through a communications means such as wired electronic means or wireless electronic means.

Electrical power may be supplied to the electronic musical instrument by means of a wired connection from mains power or from any other electrically-powered device. Alternatively, or preferably additionally, the instrument may include at least one battery for supplying electrical power. The battery could be built-in, interchangeable, external, or one of each may be included, ie a bios type built-in battery for maintaining memory settings for device and any memory cards plus a plug-in battery for powering the device in operation.

The at least one digit-activated controller may include at least one control surface or discrete device, said control surface or discrete device including a variable illumination means, the variable illumination means being varied (for example in colour, brightness, contrast, pattern, displayed image, or the like) in response to changes in one or more values controlled by said control surface or discrete device.

The electronic musical instrument may have a casing for storing, transporting and/or charging the instrument, the casing including a power supply, an amplifier and at least one speaker. The casing may include two portions connected by a hinge and may further include at least two speakers, at least one speaker being provided in each portion. The casing may include a battery charger. The casing may include batteries to supply power to the casing if the casing is unplugged from mains power. The casing may include storage for accessories such as extra batteries, sheet music, and straps.

The casing may include communication means for wired or wireless communication with said electronic musical instrument and may further include a tone generator.

The electronic musical instrument may further include a hardware or software synthesizer inside said electronic musical instrument for converting said data stream into audio data. The synthesizer may be individually replaceable. The electronic musical instrument may include a removable storage medium such as a memory card. The instrument may include at least one built-in speaker. The instrument may include a computing device and display.

The electronic musical instrument may include electronic means of accessing, displaying, editing, transferring, storing, and applying the individual music note values and music effect values, in sequence or in combination, between said electronic musical instrument and other electronic devices.

A mechanical support may be provided for attaching the instrument to the player's forearm. A supporting strap may be provided, along with a mechanism for attaching the strap to the instrument.

The at least one said digit-activated controller may include a touch-sensitive surface or touch sensitive video display.

### BRIEF DESCRIPTION OF THE DRAWINGS

The present invention will now be described, by way of example only, with reference to the accompanying drawings, in which:

FIG. 1 is a top view of a musical instrument in accordance with a first possible embodiment of the present invention;

FIG. 2 is a left side view of the musical instrument shown in FIG. 1;

FIG. 3 is a front view of the musical instrument shown in FIGS. 1 and 2;

FIG. 4 is a rear view of the musical instrument shown in FIGS. 1 to 3;

FIG. 5 is a perspective view of a musical instrument in accordance with a second possible embodiment of the present invention, shown in a “closed” or folded form position;

FIG. 6 is another perspective view of the musical instrument shown in FIG. 5;

FIG. 7 is a perspective view of the musical instrument shown in FIGS. 5 and 6, now shown open in an unfolded (substantially coplanar) form position;

FIG. 8 is a front/side view of a musical instrument in accordance with a third possible embodiment of the present invention, shown in a closed (folded) position.

FIG. 9 is a front/side view of the musical instrument of FIG. 8 shown in an open (unfolded) position.

FIG. 10 is a block diagram of the data flow between the different elements of all of the modules in the instrument of the preferred embodiment;

FIG. 11 shows a casing for housing the musical instrument in accordance with another aspect of the present invention.

FIG. 12 is a block diagram of the data flow between the electronic elements of the instrument's casing of FIG. 11.

### DESCRIPTION OF PREFERRED EMBODIMENT

A note-controlling device or surface can be called a “button,” while a bounded two-dimensional array of at least three such buttons (not all in the same line) can be called a “button-field.” The specific spatial pattern of buttons within a button-field can be called its “button-arrangement” or simply “arrangement,” and a pattern of association between musical notes and a button-field's buttons can be called a “layout.” A musical instrument including at least one such button-field can be called a “button-field instrument,” just as a musical instrument including at least one piano-style keyboard is can be called a “keyboard instrument.”

A button-field's arrangement can be “static” or “dynamic.” If the button-arrangement can be changed at the user's discretion it is dynamic, whereas if it is fixed at the time of manufacture then it is static.

A “finger-activated controller” is a button-field, or one or more finger-activated controls other than a button-field, or a combination thereof, all within the reach of the fingers of a single hand (although perhaps requiring some movement of the hand itself.

A “thumb-activated controller” is one or more controls that are designed to be operated by a single thumb, all within the reach of said single thumb (although perhaps requiring some movement of the hand itself).

A “digit-activated controller” is either a finger-activated controller or a thumb activated controller.

A device is “hand-held” if it is designed to be supported, stabilized, and positioned solely by the arm, its hand, and/or its digits. A brace can be used to affix such a hand-held instrument to the hand, wrist, or forearm, within the scope of this definition. A neck-strap can be used to relieve the arm/hand/digits of supporting the weight of the device during extended periods of use, within the scope of this definition. The ability to affix such a hand-held instrument to a stand, or to perform with it while it is supported by a table or stand, does not detract from its being considered to be a hand-held device, so long as its design facilitates use when supported, stabilized, and positioned solely by the arm/hand/digits as described above.

The basic concept of the present invention combines a hand-held electronic musical instrument, at least one button-field positioned for use by the fingers of one hand, and at least one multi-value control positioned for manipulation by the player's thumb. Ideally the thumb control would be a multi-value controller.

In the preferred embodiment, there are two separate button fields—one for each hand. Each separate button-field can be sized and arranged to place the maximum number of buttons under the span of one of the player's hands. Preferably, the button-arrangement facilitates the simultaneous pressing of one, two, or even three adjacent buttons with a single fingertip. In the preferred embodiment, the buttons of the button-fields are used during performance primarily to play notes, like the buttons on a concertina.

Also in the preferred embodiment, additional controls are positioned to be manipulated by the players' thumbs, primarily for the purpose of adding musical expression to the notes being played with the fingers. Such effects include but are not limited to pitch bending, brightness, portamento time, reverb depth, and other such musical effects.

This combination allows both a high degree of polyphony and a high degree of musical expressiveness, in an instrument that can be remarkably small and light. Being small and light makes the instrument easier to play for extended periods, and opens the door to other benefits which are beyond the scope of the present invention.

As is known to those versed in the art of electronic music, many electronic instruments provide different modes of operation. In a mode that might be called “performance mode,” for example, pressing a finger-operated button might sound a note, whereas in a mode that might be called “setup mode,” pressing this same button might select a musical effect variable for modification, select a different sound for the instrument, or perform some other function quite distinct from its function in “performance mode.” In the preferred embodiment, the transition from one mode to another can be effected through the manipulation of the instrument's thumb controls, although other means such as foot-controlled switches or breath-pressure controls, known to those familiar with the art, could be used.

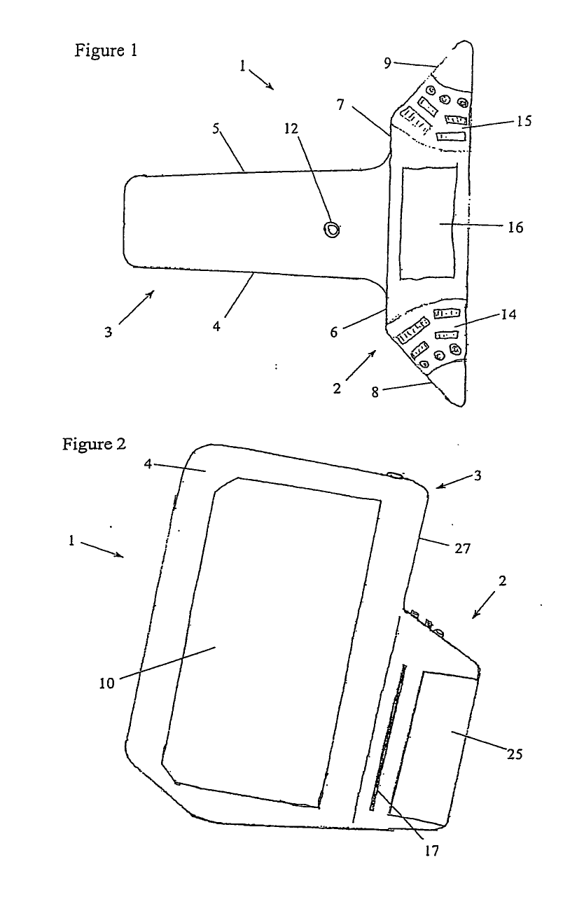

Referring initially to FIG. 1 there is shown a first possible embodiment of an electronic musical instrument 1, according to the present invention. The body of the instrument includes two main portions, a rearward transverse portion 2, which is held in the palms of the player's hands, and a tapering forward vertical portion 3, which forms the finger/instrument interface.

Buttons can be provided on any or all of the surfaces 4, 6 and 8 for the fingers of the player's left hand and on any or all of the surfaces 5, 7 and 9 for the fingers of the player's right hand.

It should be noted that the primary purpose of the finger-activated controller is to provide signals indicative of the pitch of the sound the player wishes to produce, this signal can be referred to as a music note value. However, the finger-activated controller can also provide other signals such as attack velocity, release velocity and pressure or after-touch, or further signals such as pitch bend and modulation, depending on the configuration of the finger-activated controller. These other signals and further signals can be referred to as music effect values. It is also envisaged that at least one of the finger-activated controllers provide music note value signals and that at least one of the other finger-activated controllers provide music effect value signals. The finger-activated controllers can also include areas, buttons, sliders or other forms of input control device to permit additional functionality. For example, an octave switch can be provided as part of a finger-activated controller to switch the pitch of the controller output by whole octaves.

A jack 12 is shown, which could be used for audio output such as for headphones. The headphone jack could be positioned at any convenient point on the instrument and could additionally have a volume control input alongside (not shown) or user one of the other input controllers on the instrument.

Another possible input device is a breath controller which can be used in combination with the finger-activated controller, the breath controller producing some music effect values in addition to the music note values (and usually the additional music values) produced by the finger-activated controller. Conventional foot switches and continuously variable foot pedals can also be used, however these limit the player to a position while using them and provide no benefit in control over the use of the thumb-activated controllers so are generally unnecessary encumbrances. These jacks are general-purpose, however, and could be used to input data from alternative controllers such as elbow-angle sensors, bagpipe-bag air-pressure sensors, or any other sensor.

Also shown on the instrument in FIG. 1 are thumb-activated controllers 14 and 15. Each thumb-activated controller can include one or more input devices which can be of any known type including buttons, sliders, rotary adjusters, proximity sensors, or any positional input devices such as joysticks, touch pads or other control surfaces. The thumb-activated controllers shown in FIG. 1 are multiple input controllers. Although it is possible that only one thumb controller be provided to control a single music effect value, it is preferable to provide at least one thumb controller for each thumb.

Although the thumb-activated controllers are primarily provided to generate music effect values, they can, in addition or alternatively, be configured to generate music note values, or programmed to perform other functions. For example, a number of buttons could be provided and programmed to produce different individual (or patterns of) music note values corresponding to say a base line, or to produce chords used in the piece of music being performed.

It should be understood that the finger-activated controllers and the thumb activated controllers can each produce music note data, music effect data and instrument metadata.

The finger-activated controllers and the thumb-activated controllers can be designed to generate music note values and music effects values in a proprietary format or an industry standard format such as, for example, the Musical Instrument Digital Interface (MIDI) format or the Open Sound Control (OSC) format. The signals from the different controllers can be combined into a single data stream which may have a number of channels (like the 16 used in MIDI) with each finger- or thumb-activated controller (or even assignable portions of each finger- or thumb-activated controller) being assigned to any one or more of the available channels. Alternatively, the finger- and thumb-activated controllers can communicate the values to other electronic devices inside or external to the electronic musical instrument which in turn then generate data in a standard format. Alternatively, or additionally, the finger-activated controllers and the thumb-activated controllers can communicate with other electronics inside and/or external to the instrument which generate audio signals.

A sequencer function can be provided in the electronics of the instrument, or in the electronics of any other device which communicates with the instrument.

Although the musical instrument can be plugged into an external display unit, or another device with a display, or it can include displays as part of the finger- or thumb-activated controllers, it may be desirable in some embodiments to provide a dedicated display screen 16. The display screen can be used to indicate instrument voices selected at the time, music effects currently in use, the part of a music score currently being played, or other such data whilst the user is playing the instrument. Alternatively, it can be the sole display available to the user, so it may display any data and may itself be touch sensitive, thus could be both a display device and a general-purpose input device.

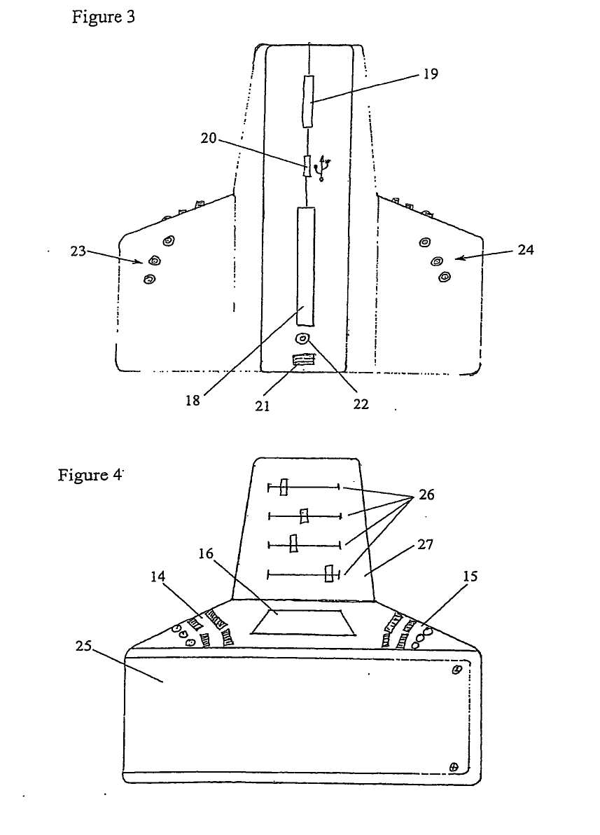

The T-shape of the electronic musical instrument of FIGS. 1, 2 and 3 is designed to allow the user to operate the finger and thumb-activated controllers around a convenient electronic package including a motherboard and at least one daughterboard located at right angles to each other. The motherboard can be located in the rearward transverse portion 2 of the instrument, along the line shown at 17 in FIG. 2. Then the daughterboard (such as a tone generating sound card) can be plugged into the motherboard through the slot 18 in the front of the instrument as shown in FIG. 3. Also shown in FIG. 3 is a further slot 19 for a memory module. This memory module could be used to import data relating to audio synthesis of different instruments, to record sequencer data of musical composition or preformances, or for the importing, storing and/or exporting of any other data.

A multi-purpose connection port 20 is shown on the front of the instrument (shown in the example in FIG. 3 adjacent to a Universal Serial Bus symbol, but this can be any standard or proprietary format port). The port is provided to transmit, to or from the instrument, power, music note values, music effect values, music industry standard format data, audio signals, instrument metadata such as sound generation model parameters or samples, or any other data.

The power button 21 for the instrument is shown next to a direct audio out jack 22. The direct audio out jack could be replaced or complemented by a digital audio out connector.

Additional finger activated control devices 23 and 24 can be provided on the front faces of the rearward transverse portion of the instrument. The additional finger-activated control devices 23 for the right hand and 24 for the left hand, can include similar devices or a combination of devices such as buttons, joysticks, sliders and/or touch pads.

A power supply connection can be provided for supplying power to the musical instrument for operation and charging internal batteries. It can be advantageous to provide this dedicated power supply connection if the multi-purpose connection port 20 is omitted or if the instrument sits in any charging cradle or in a protective carry case which includes a power supply. The primary battery 25 for the instrument is shown in the rearward transverse portion of the instrument in FIGS. 2 and 4. Additional small batteries may be provided inside the instrument to maintain a system clock, memory of settings, etc.

Also shown in FIG. 4 is a set of additional thumb-activated controllers 26 on the uppermost rearwards facing surface on the instrument 27. These controllers are shown as sliders, but again can include any similar devices or a combination of devices such as buttons, joysticks, sliders, touch pads, track balls, touch screens or the like.

The package of the musical instrument shown in FIGS. 1 to 4 is compact and easy to play, so is practical for use as a general purpose instrument. However, other packages are possible and can be designed to better suit a particular situation or set of requirements.

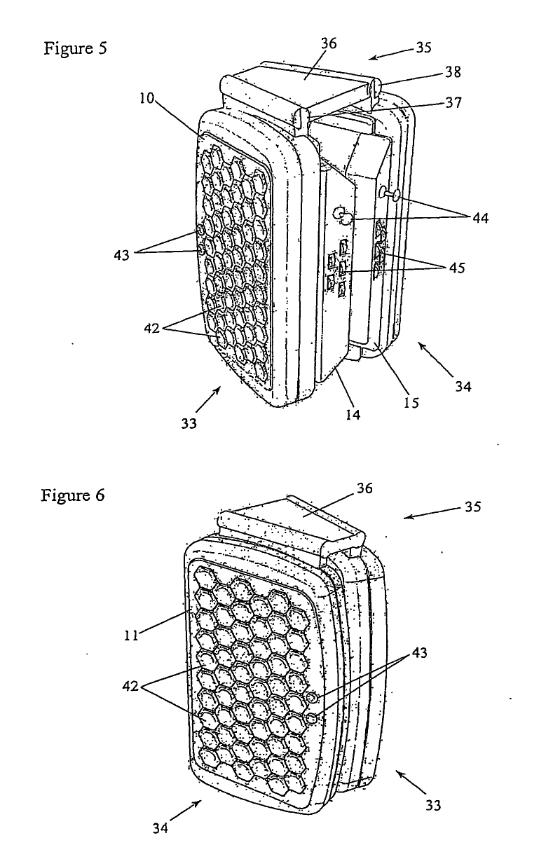

FIGS. 5 to 7 show a second possible embodiment of electronic musical instrument according to the present invention. Like items are accorded like reference numerals. The instrument includes a left hand digit-activated unit 33 and a right hand digit-activated unit 34 joined together by a hinge mechanism 35.

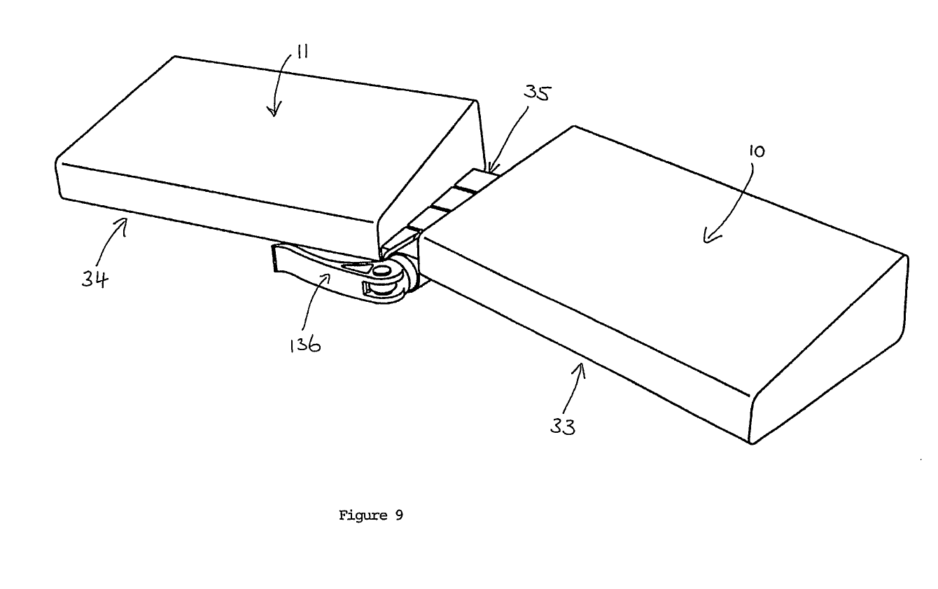

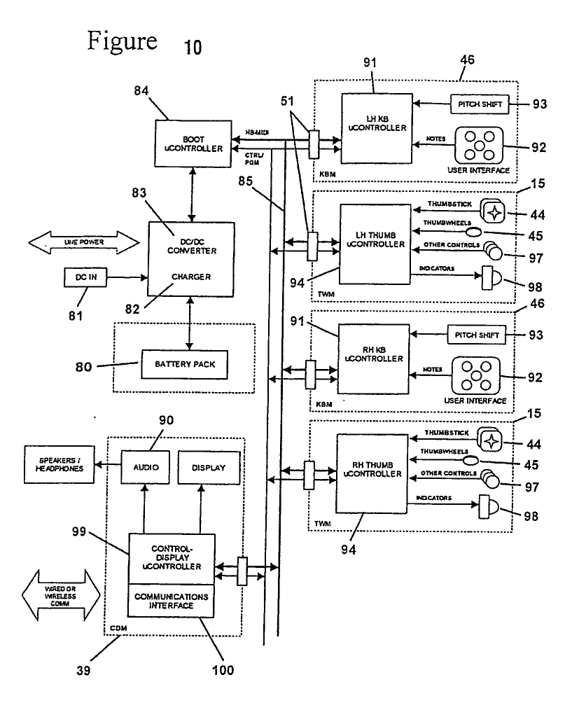

Another possible embodiment of such a hinge mechanism 35 is shown in FIGS. 8 and 9. Like items are accorded like reference numerals. This hinge mechanism includes a locking lever 136, shown in the locked position. If the lever is moved so that its length is parallel with the rest of the hinge mechanism 35, the angle between the two units 33 and 34 of the instrument can be changed freely. Returning the locking lever 136 to the position shown locks the hinge mechanism 35, maintaining a constant angle between the two digit-activated units 33 and 34.

Those familiar with hinges know that many hinge designs exist which could be used to join the digit-activated units 33 and 34, and the claims of this invention are not limited to the hinge designs shown herein.

The inclusion of a hinge makes the present invention both easier to learn and easier to play.

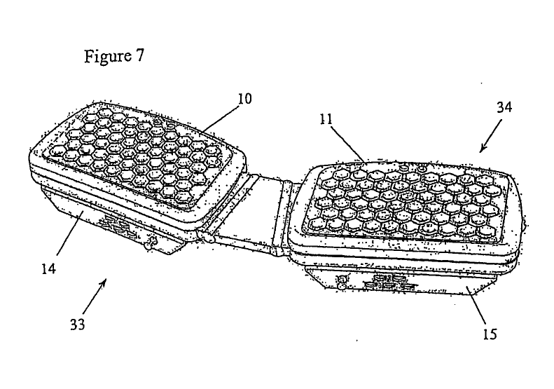

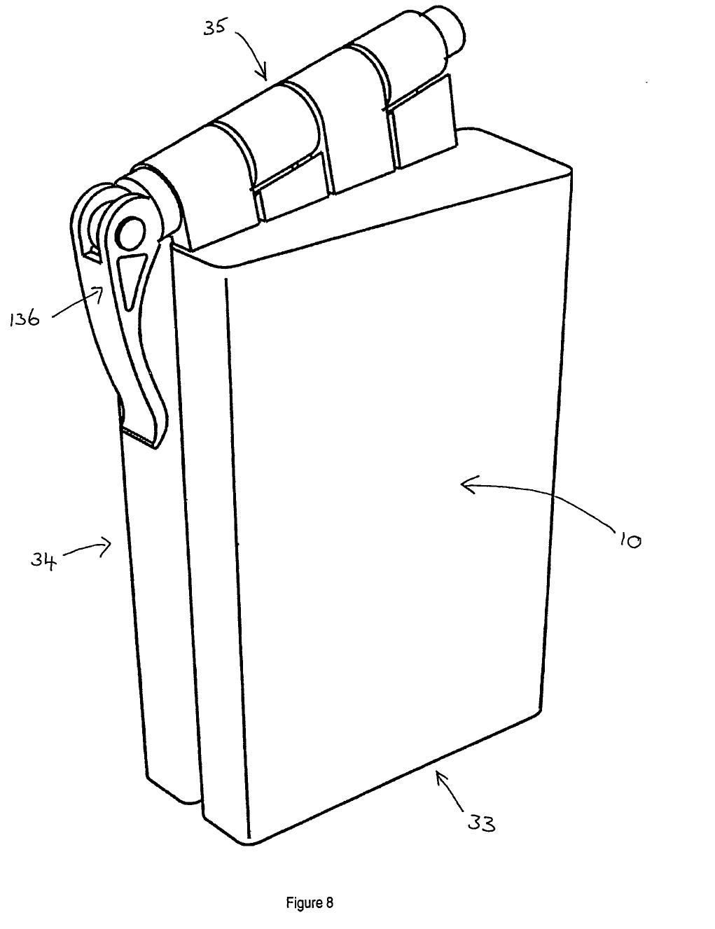

When the two digit-activated units 33 and 34 are unfolded as shown in FIG. 7, the two finger activated control surfaces are substantially coplanar. This allows the player to see all of the available finger-activated control surfaces, just as pianist can see all of a piano's keys when playing. This makes the location and selection of individual buttons easier for novices to learn.

Observe that, with the hinge mechanisms 35 shown, changing the angle between the digit-activated units 33 and 34 does not change the angle between a given unit's finger activated control or surface (10 or 11) and thumb-activated control surface (14 or 15). That is, the relationship between a player's thumb and fingers does not change when the instrument is folded to one degree or another. Therefore the thumb-finger coordination learned most easily when the instrument is unfolded into an open position is directly applicable when the instrument is folded into a closed position or any intermediate position.

When the left and right hand units are folded together as shown in FIGS. 5 and 6, the instrument is played in a similar fashion to the instrument shown in FIGS. 1 to 4, with the instrument usually resting on the player's lap or being suspended by a strap from the player's neck and shoulders or supported from the player's torso, waist, arm, or wrist. This form factor is similar to a concertina in terms of the player's finger movements and hand positions.

Just as the present invention's unfolded position has ease-of-learning advantages, the folded position as shown in FIGS. 5 and 6 has ease-of playing advantages, relative to a non-hinged version that is fixed in the open position shown in FIG. 7. The more compact form makes it easier to support, stabilize, and position with the digits/hand/arm, and therefore easier to play.

Thus having a hinge mechanism 35 joining the digit-activated units 33 and 34 makes the present invention both easier to learn and easier to play.

There is no display illustrated on the electronic musical instrument shown in FIGS. 5 to 7. Instead, as for any embodiment of the electronic musical instrument, the input controllers can be connected by a cable or wirelessly to another device. The other device can be a Personal Digital Assistant (PDA) which is used as the display device for the electronic musical instrument. The other device can alternatively be a mobile phone, Personal Computer (PC) pocket PC or any other device with a display and/or a polyphonic sound generating capability. One particularly useful alternative is the tablet PC which can be used to display sheet music at full size in addition to providing a Graphical User Interface (GUI) for control of the electronic musical instrument. Indeed with sound generating chips emerging having 64-note polyphony and a compact package (for use in mobile phones) the electronic musical instrument can be an input controller (generating music note values and music effect values) without the need for any on-board sound generating hardware to be provided. If a PDA or other external device is used to display an external GUI for the musical instrument, there can still be at least one display provided on the actual instrument to enable the instrument to be used as a stand-alone unit or to give simple feedback of settings and the like to the user.

Each digit-activated unit (33 or 34) includes a finger activated control or surface (10 or 11) and a thumb-activated control surface (14 or 15). The finger-activated control surface (10) for the left hand is shown in this case as a button-field 42. Two additional finger-activated buttons 43 are also shown on each finger-activated controller. These can perform any desired user assignable functions, send music note values, music effect values, or be preset to perform tasks such as shifting the music note values generated by the buttons (42) of the main array by a chosen pitch (such as a fraction of a tone for micro-tuning, a semi-tone for transposing or one or more octaves for shifting registers). An alternative use for the additional finger-activated buttons 43 is to control effects such as illumination on/off or style of illumination for the finger activated controllers or the whole instrument.

Each thumb control region 14 and 15 is exemplified incorporating a thumb stick 44 and five thumb wheels 45. The thumb sticks can act as digital or analogue 2-axis controllers or joysticks and further include a digital switch activated by depression of the thumb stick 44. The thumb sticks may alternatively produce a variable or analogue signal indicative of the force applied to depress the thumb stick. The thumb wheels 45 are single-axis controllers, (usually analogue) and can be designed to produce a digital or variable signal when depressed.

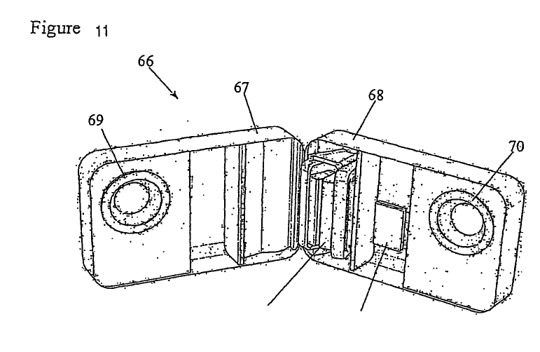

FIG. 10 shows a possible circuit block diagram for the electronic musical instrument of FIGS. 5 to 7, showing the battery pack 80 (and/or the jack for an optional external battery pack), line power connectors 81, (optional) charger 82, DC/DC converter 83, boot micro-controller 84, and data bus 85.

A multi-purpose carrying case can be provided for any embodiment of the electronic musical instrument of the present invention. FIG. 11 shows a multi-purpose carrying case 66 for the electronic musical instrument shown in FIGS. 5 to 7, although it can be adapted to suit any electronic musical instrument according to the present invention. The case 66 is designed to open into two 25 halves 67 and 68 which are either hinged or separable, there being at least one speaker 69, 70 in each half of the case. Additionally, the case can include storage areas, pockets, clips, moldings and the like to accommodate the instrument and any accessories, cables, music, a tablet PC, or anything else that accompanies or is used with the instrument. For example, a PDA, 71, is shown 30 housed in an area inside the case. If any device such as a PDA or tablet PC is used with the instrument and the case, it can provide many functions such as sound generation, a display, and it is preferably also used to act as the host for those wired or wireless communication systems which require a host device.

To ease transportation of the case 66, wheels and handles can be provided (not shown). The design of the wheels and handle can be similar to that commonly found on most suitcases. The handle can be extendible or telescoping, and could include, in some embodiments, an antenna for wireless communication with the instrument. The handle can even be used either in its normal position, or clipped into a new position on the case to provide a music stand function for holding sheet music, a PDA, tablet PC or any other device used with the electronic musical instrument. Alternatively a purpose built stand or holder can be included in the design of the case. The stand can include a power connection to accept the PDA or tablet PC or the like or any other wires or clamps for any other devices such as microphones which can be used together with the musical instrument and case.

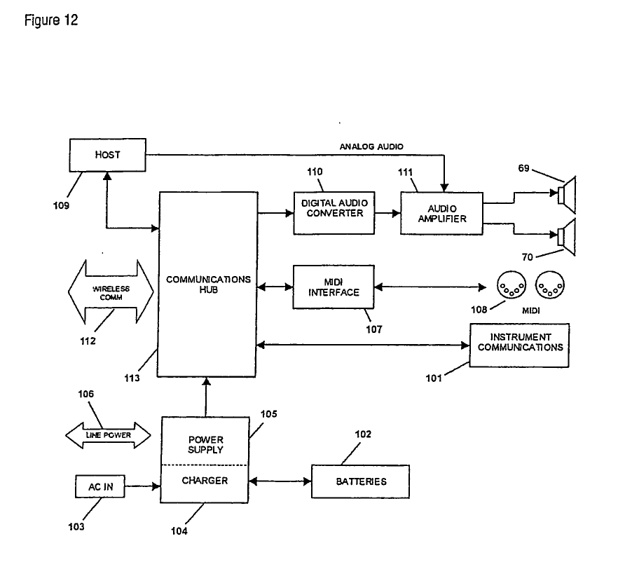

FIG. 12 shows a possible embodiment of the electronic functionality housed within case 66. It can include a charging unit 104 for the instrument and/or a power supply 105 for converting power (ideally from a variety of sources such as from the mains 103 at 110 or 240 volt AC or any DC supply such as a 12 or 24 volt car battery) to supply the charger 104, the musical instrument directly 106, or any other associated electronics. The case can even include a battery 102 for providing power to any electronics in the casing and/or to the instrument. Examples of the associated electronics that are preferably built into the multi-purpose carrying case 66 are an amplifier 111 and one or more speakers 69 and 70. The case can even include a tone generator, audio and data input and output connectors and can incorporate a wireless communication device 112.

Dynamic and Static Button-Arrangements

Acoustic keyboard instruments such as the piano and organ, and acoustic button-field instruments such as the concertina and chromatic button accordion, have static button-field arrangements. That is, the size, shape, and spacing of their (physical) note-controlling buttons (or keys) is determined at the time of manufacture.

An electronic instrument can also have this same kind of static arrangement of physical buttons. Alternatively, being electronic, it could have a more dynamic arrangement of “virtual” buttons on its at least one button-field.

The use of static buttons brings benefits and disadvantages. Static buttons, being physical, can provide tactile and kinaesthetic feedback to the player regarding the position of the fingers on the control surface. The primary disadvantage of a button-field composed of static buttons is a lack of flexibility.

Alternative control surfaces (10) are possible which are more flexible and adaptable than a fixed button-field composed of individual sensors. Many provide the ability to sense several points on a two dimensional surface with high resolution. This allows for the surface to be electronically “divided” up, providing a virtual button-field of any desired arrangement and/or layout. Also, a mix of note-controlling buttons and other virtual inputs or controls could be programmed in.

One possible embodiment of a dynamic button-arrangement is, for example, a contact and/or pressure sensing fabric.

Another possible embodiment of a dynamic button-arrangement is a touch-sensitive display. This embodiment would have the advantage of displaying visually the regions of the control surface that were associated with each button. Such a display, if general-purpose, could optionally be used as an interactive display of any kind of data, whether in performance mode or in other modes.

Dynamic button-arrangements would, in currently-known embodiments, be unable to provide tactile or kinaesthetic feedback to distinguish a given button from another, or from a non-button surface region. Overlays could be provided for known alternative button-arrangements, each with surface features such as finger-tip sized concave regions, raised portions, or the like, to help the player locate and manipulate the desired buttons.

The overlays can have text incorporated to denote the function of particular discrete areas of the control surface. The overlays can also include illumination which can take many forms and be used for many purposes. For example, as a learning tool, the overlay can be made to change colour or luminescence on or around one or more discrete areas on the control surface to indicate that the player should touch the surface in the area(s) indicated. The overlay can be made to change colour or luminescence on or around one or more discrete areas on the control surface in response to contact or pressure at the one or more discrete areas. The overlay can be made to illuminate in different ways in response to the signals generated by the control surface, audio signals, randomly, or in any pre-programmed way. Alternatively, or additionally, the overlay can be a display surface capable of displaying any desired images or information, including the division of the control area into discrete input areas such as virtual buttons or any other inputs such as sliders, and text indicating the assignment of each discrete input area.

1-10. (canceled)

11. A portable user operated button-field electronic music controller including:
at least one finger actuated note identifier input button in a first zone actuated by at least one finger of a users first hand to generate at least one note identifier output used to create one or more musical notes, said at least one finger actuated note identifier input button arranged to be actuable by each of at least one finger of said users first hand; and
at least one thumb actuated effect identifier input device in a second zone actuated by said users thumb on said first hand to generate at least one effect identifier output used to modify said one or more musical notes;
wherein the arrangement of said first and second zones allows simultaneous operation of said at least one finger actuated note identifier input button and said at least one thumb actuated effect identifier input device.

12. A controller as claimed in claim 11 wherein said at least one thumb actuated effect identifier input device is multi-variate.

13. A controller as claimed in claim 11 wherein, when playing any said finger actuated note identifier input button with said at least one finger of a given hand, any of said at least one thumb actuated effect identifier input devices can be reached with the thumb of that hand.

14. A controller as claimed in claim 11 wherein said at least one finger actuated note identifier input button further generates music effect values.

15. A controller as claimed in claim 14 wherein said music effect values include force, pressure and/or velocity sensitivity values.

16. A controller as claimed in claim 11 wherein said effect identifier output include effect identifiers of MIDI or OSC such as, pitch bending, brightness, portamento time, and/or reverb depth.

17. A controller as claimed in claim 11 wherein said thumb actuated effect identifier input device is a button, slider, dial, proximity sensor, joystick, or touch pad.

18. A portable user operated electronic music controller including:
at least one finger actuated note identifier input device in a first zone actuated by at least one finger of a users left hand to generate at least one note identifier output used to create one or more musical notes, said at least one finger actuated note identifier input device in said first zone arranged to be actuated by each of at least one finger of said users left hand; and
at least one thumb actuated effect identifier input device in a second zone actuated by said users thumb on said left hand to generate at least one effect identifier output used to modify said one or more musical notes;
wherein the arrangement of said first and second zones allows simultaneous operation of said at least one finger actuated note identifier input device in said first zone and said at least one thumb actuated effect identifier input device in said second zone by said left hand of said user;
said controller further including:
at least one finger actuated note identifier input device in a third zone actuated by at least one finger of a users right hand to generate at least one note identifier output used to create one or more musical notes, said at least one finger actuated note identifier input device in said third zone arranged to be actuated by each of at least one finger of said user's right hand; and
at least one thumb actuated effect identifier input device in a fourth zone actuated by said users thumb on said right hand to generate at least one effect identifier output used to modify said one or more musical notes;
wherein the arrangement of said third and fourth zones allows simultaneous operation of said at least one finger actuated note identifier input device in said third zone and said at least one thumb actuated effect identifier input device in said fourth zone by said right hand of said user;

19. A controller as claimed in claim 18, in which said first and second zones are in a first portion and said third and fourth zones are in a second portion, and wherein said first and second portions are joined with a hinge.

20. A controller as claimed in claim 18 wherein said at least one thumb actuated effect identifier input device is multi-variate.

21. A controller as claimed in claim 18 wherein, when playing any said finger actuated note identifier input device with said at least one finger of a given hand, any of said at least one thumb actuated effect identifier input devices can be reached with the thumb of that hand.

22. A controller as claimed in claim 18 wherein said at least one finger actuated note identifier input button further generates music effect values.

23. A controller as claimed in claim 22 wherein said music effect values include force, pressure and/or velocity sensitivity values.

24. A controller as claimed in claim 18 wherein said effect identifier output include effect identifiers of MIDI or OSC such as, pitch bending, brightness, portamento time, and/or reverb depth.

25. A controller as claimed in claim 18 wherein said thumb actuated effect identifier input device is a button, slider, dial, proximity sensor, joystick, or touch pad.
